(19) United States
(12) Patent Application Publication
(10) Pub. No.: US 2017/0235361 A1
(43) Pub. Date: Aug. 17, 2017

(54) INTERACTION BASED ON CAPTURING USER INTENT VIA EYE GAZE

(71) Applicant: Panasonic Automotive Systems Company of America, Division of Panasonic Corporation of North America, Peachtree City, GA (US)

(72) Inventors: LUCA RIGAZIO, LOS GATOS, CA (US); CASEY JOSEPH CARLIN, SAN JOSE, CA (US); ANGELIQUE CAMILLE LANG, SAN JOSE, CA (US); MIKI NOBUMORI, SANTA CLARA, CA (US); GREGORY SENAY, SANTA CLARA, CA (US); AKIHIKO SUGIURA, EAST PALO ALTO, CA (US)

(73) Assignee: Panasonic Automotive Systems Company of America, Division of Panasonic Corporation of North America

(21) Appl. No.: 15/411,671

(22) Filed: Jan. 20, 2017

Related U.S. Application Data
(60) Provisional application No. 62/281,098, filed on Jan. 20, 2016.

(51) Int. Cl. G06F 3/01; B60R 16/037; G06F 9/44; G06F 3/0484; G06F 3/16; G10L 15/22

(52) U.S. Cl. CPC G06F 3/013; G06F 3/167; G10L 15/22; G06F 9/4446; G06F 3/04842; B60R 16/037

(57) ABSTRACT

Exemplary embodiments of the present invention relate to an interaction system for a vehicle that can be configured by a user. For example, an interaction system for a vehicle can include an image capture resource to receive eye image data of a user. The interaction system for a vehicle can also include a processor to identify a direction of an eye gaze of the user based on the eye image data. The processor can correlate the eye gaze to a driving experience function (DEF), and the processor can transmit a DEF communication.

### CROSS-REFERENCED TO RELATED APPLICATIONS

This application claims benefit of U.S. Provisional Application No. 62/281,098 filed on Jan. 20, 2016, which the disclosure of which is hereby incorporated by reference in its entirety for all purposes.

### FIELD OF THE INVENTION

The present invention generally relates to interactions with computing systems in a vehicle. More specifically, the present invention relates to a system for identifying user intent from the user's eye gaze.

### BACKGROUND OF THE INVENTION

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Vehicles, such as cars, trucks, SUVs, minivans, and boats, among others, can have systems that use input from a user to provide feedback or fulfill requests of the user related to the driving experience. For example, a vehicle can use a user input to adjust volume of a radio or other system. In another example, a vehicle can have an interface with physical buttons and inputs to allow a user to manipulate the interface. In a navigation sense, the vehicle can use this interface to identify a user provided location either through direct input on the interface or through voice command by the user.

The present disclosure presents techniques to replace interactions that are initiated by, operated by, or otherwise use physical input from a user. For example, activities in a vehicle that preoccupy the user's, and especially the driver's, hands can be distracting and reduce safety. The use of eye gaze in the presently disclosed techniques provides a way for the user to make a selection, initiate an interaction, and otherwise direct interactions with their eyes. The presently disclosed techniques present quick and accurately interactions with a vehicle that reduce a user's lack of focus by removing, where possible, a user's physical interaction with a vehicle.

The use of eye gaze creates a more intuitive and combined experience that can be combined with additional eye gaze input, voice input, and tactile interaction to create a sense that the system of a vehicle understands the user's intent. In an example, the use of eye gaze as part of a more universal input device also allows the reduction of user input mechanisms needed in a vehicle, especially when compared with previous button filled consoles of present vehicles. The presently disclosed techniques allow for the selection of the target of interest using a single intuitive action rather than learning layouts and locations of the controls for the numerous activities often offered to drivers.

### SUMMARY OF THE INVENTION

An exemplary embodiment can include an interaction system for a vehicle. The system can include an image capture resource to receive eye image data of a user; a processor to identify the eye gaze of the user based on the eye image data, the processor to correlate the eye gaze to a driving experience function (DEF), and the processor to transmit a DEF communication. In an embodiment, if the eye gaze is in the direction of a virtual assistant location, correlates to a DEF of a user command request; and the DEF communication comprises an activation of voice receipt and recognition resources as well as a prompt to the user. Optionally, the prompt to the user comprises at least one of the following: audio signal, haptic feedback, and a visual cue. Optionally, the processor is to transmit a received audio input of a user to a natural language understanding model to generate a user input interpretation, the prompt to the user to be based on the user input interpretation.

In another embodiment, the eye gaze is in the direction of a dashboard adjustable instrument location correlates to a DEF of a control request of a dashboard adjustable instrument; and the DEF communication comprises an activation of a physical control to receive input from a user. In another embodiment, the eye gaze is in the direction of a dashboard adjustable instrument location correlates to a DEF of a control request of a dashboard adjustable instrument; and the DEF communication comprises an activation of a displayable control visible to the user. The image capture resource receives second eye image data. The processor to identifies a second eye gaze of the user based on the second eye image data and correlates the second eye gaze to a selection of an option to be shown on the displayable control, the option correlating to an adjustment of the dashboard adjustable instrument.

In another embodiment, the eye gaze is in the direction of a dashboard display location and correlates to a DEF of a read-out request of a dashboard display function. The DEF communication comprises an instruction to broadcast to the user a value of the dashboard display.

In another embodiment, the eye gaze correlates to a DEF of a nonverbal user communication; and the DEF communication comprises an instruction to notify the user based on the nonverbal user communication. Optionally, the nonverbal user communication indicates a drowsy user and the instruction to notify the user comprises at least one of an audio signal, haptic feedback, and a visual cue. Optionally, the nonverbal communication, if the eye gaze is in the direction of the horizon, indicates a weather inquiry and the instruction to notify the user comprises a least one of an audio signal and a visual cue.

In another exemplary embodiment, a method for user and vehicle interaction can include receiving eye image data of a user at an image capture resource; identifying, with a processor, an eye gaze of the user based on the eye image data; correlating, with the processor, the eye gaze to a driving experience function (DEF); and transmitting, with a processor, a DEF communication.

Another exemplary embodiment can include a vehicle for interaction with a user. The vehicle for interaction with a user includes an ignition system; an image capture resource to receive eye image data of a user; a processor to identify an eye gaze of the user based on the eye image data and to correlate the eye gaze to a driving experience function (DEF), the processor to transmit a DEF communication.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a drawing of an example interaction system for a vehicle showing an eye gaze correlating to a dashboard adjustable instrument location and input by a user input of an activated physical control;

FIG. 2 is a drawing of an example interaction system for a vehicle showing an eye gaze correlating to a dashboard display location and a broadcast of a value of the dashboard display;

FIG. 3 is a drawing of an example interaction system for a vehicle showing an eye gaze correlating to a nonverbal user communication and a notification to the user based on the nonverbal user communication;

FIG. 4 is a drawing of an example interaction system for a vehicle showing an eye gaze correlating to a virtual assistant location and voice input by the user, resulting in a prompt to the user;

FIG. 5 is a schematic diagram illustrating an example method for an interaction system to operate for a vehicle;

FIG. 6 is a schematic diagram illustrating an example method for an interaction system to operate for a vehicle;

FIG. 7 is a process flow chart of a simplified method for an interaction system to operate for a vehicle.

Correlating reference characters indicate correlating parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Exemplary embodiments of the present invention relate to a vehicle receiving input that can include analysis of a user's eyes. From the direction of a user's eye gaze, a desired action or interface of interest to control the vehicle's operation of an on-board system can be determined. For example, in the present disclosure, interaction based on the present disclosure refers to a system that tracks the direction of the user's eye gaze to predict user needs and intent. The user can further interact with the system via voice, or through a tactile input device to manually control the intended target of interest set by the direction of the eye gaze. Once a target of interest by a user can be identified based on the user input, an action can be selected based on the resources or actions activated by the detected eye gaze.

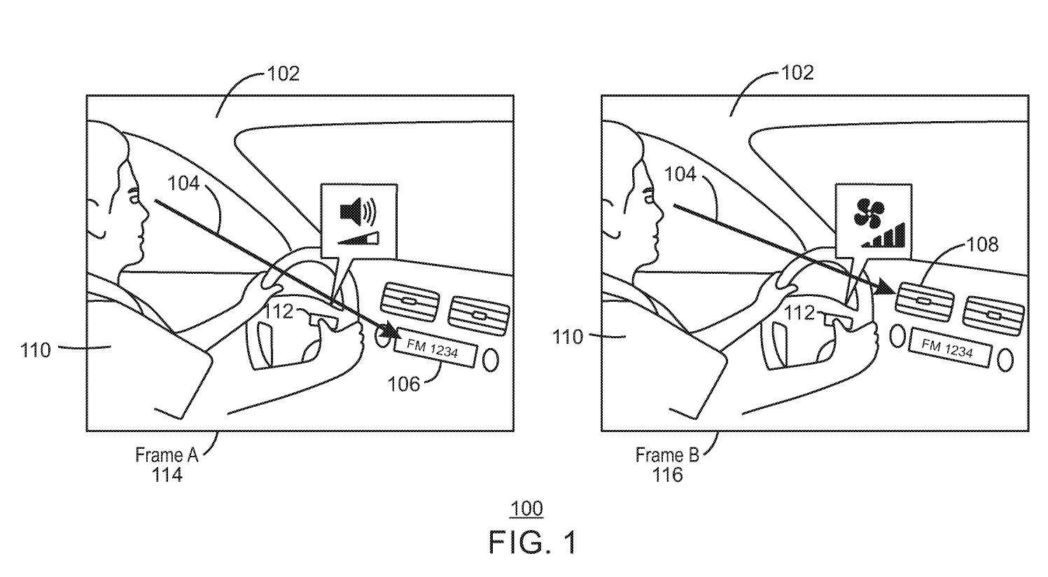

FIG. 1 is a drawing of an example interaction system 100 for a vehicle 102 showing an eye gaze 104 correlating to a dashboard adjustable instrument location 106, 108, and input by a user 110 of an activated physical control 112. Frame A (114) shows a first view in time of FIG. 1 and Frame B (116) shows the second view in time through one example use of the presently disclosed technique. Other devices, orders, and timings can also be enabled through these techniques. As shown in Frame A (114), a user's 110 eye gaze 104 correlates to a dashboard adjustable instrument location 106 of a dashboard adjustable instrument, here a car radio. The user 110 can also be seen controlling an adjustable feature of the dashboard instrument by manipulating an activated physical control 112. In this example, the activated physical control can be a touch sensitive pad on a steering wheel of the vehicle that a user 110 can place a finger or thumb across in order to raise or lower the volume.

In Frame B (116), a user's 110 eye gaze 104 correlates to a dashboard adjustable instrument location 106 of a dashboard adjustable instrument, here an air-conditioning vent. The user 110 can also be seen controlling an adjustable feature of the dashboard instrument by manipulating an activated physical control 112. In this example, the activated physical control can be a touch sensitive pad on a steering wheel of the vehicle that a user 110 can place a finger or thumb across in order to raise or lower the air-conditioner fan speed. In this example, the physical control 112 can be the same single physical hardware that can change in function depending on a user's 110 eye gaze 104, and the physical control 112 could instead include multiple hardware components. In an example, the physical control 112 may not be activated until a user's gaze correlates to a dashboard adjustable instrument.

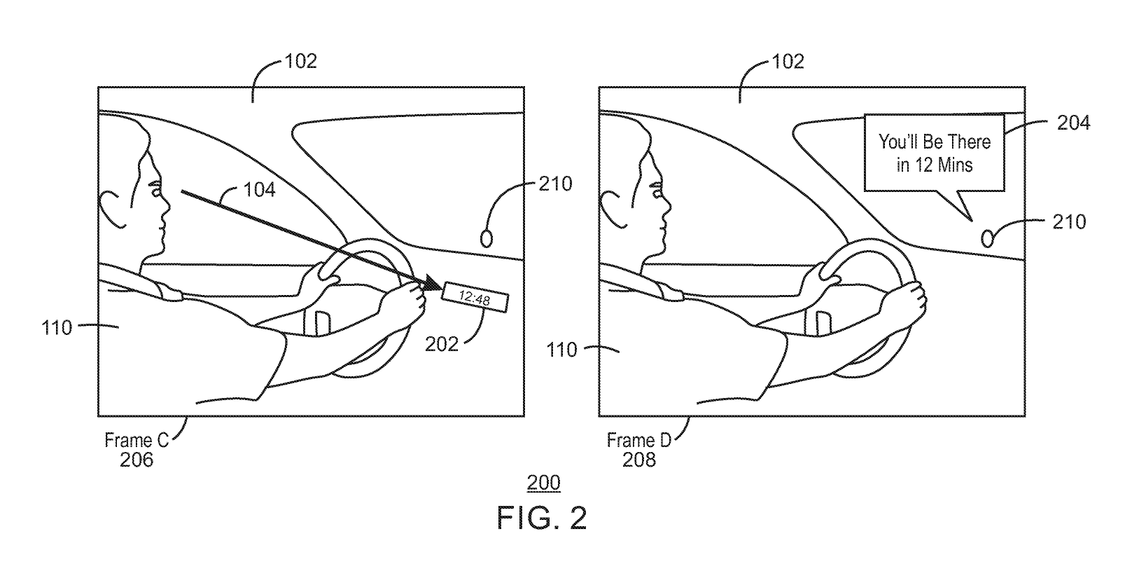

FIG. 2 is a drawing of an example interaction system 200 for a vehicle 102 showing an eye gaze 104 correlating to a dashboard display location 202 and an audible broadcast 204 of a value of the dashboard display. Like numbered items are as described with respect to FIG. 1. Frame C (206) shows a first view in time of FIG. 2 and Frame D (208) shows the second view in time through one example use of the presently disclosed technique. Other devices, orders, and timings can also be enabled through these techniques. As shown in Frame C (206), a user's 110 eye gaze 104 correlates to a dashboard display location 202 of a dashboard display, here a clock. In Frame D (208), a virtual assistant 210 can audibly broadcast 204 a value of the dashboard display. In this example, the virtual assistant 210 appears as a visually displayed avatar, the broadcast 204 is an audio broadcast, and the value of the dashboard display reflects the estimated time of arrival. An example value of the dashboard display can be a precise read out being displayed, but as seen in FIG. 2, can also be an intuitive action based on an intent identified by a user's 110 eye gaze 104 landing on a particular dashboard display location 202. A virtual assistant 210 can take many forms and need not be a visible avatar. A broadcast can be shown visibly, projected audibly, or transmitted to a user through other suitable techniques.

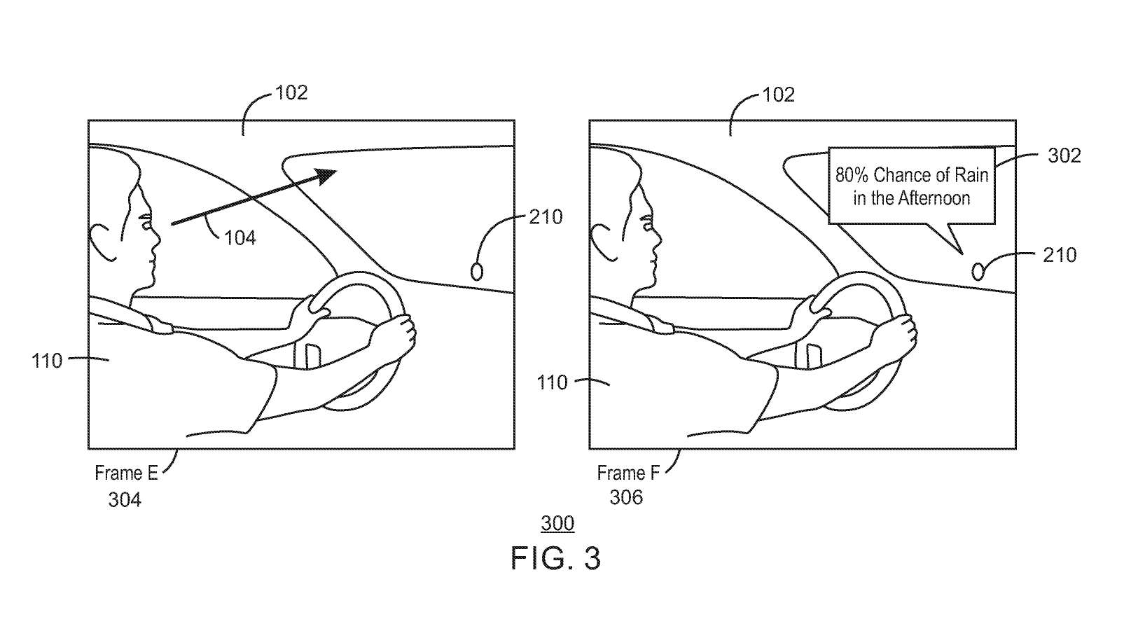

FIG. 3 is a drawing of an example interaction system 300 for a vehicle 102 showing an eye gaze 104 correlating to a nonverbal user communication and a notification to the user 110 based on the nonverbal user communication. Like numbered items are as described with respect to FIG. 1 and FIG. 2. Frame E (304) shows a first view in time of FIG. 3 and Frame F (306) shows the second view in time through one example use of the presently disclosed technique. Other devices, orders, and timings can also be enabled through these techniques. As shown in Frame E (304), a user's 110 eye gaze 104 correlates to a nonverbal user communication. In the example shown in Frame E, the user's 110 eye gaze 104 correlates to a glance upwards through the front windshield. Alternatively, the glance can be directed towards the side windows, above the horizon. In an example, the user gaze for a weather prompt can be through any window and need not be through the front windshield. In Frame F (306), a virtual assistant 210 can provide a notification to the user 110 based on the nonverbal user communication. In this example, the virtual assistant 210 appears as a visually displayed avatar, the notification 302 can be an audio broadcast. In this example, the notification based on the nonverbal user communication can include a report of the weather in the near future, as well as the current temperature. Other nonverbal communications can be indicated by a user's 110 eye gaze 104. In an example, a list of nonverbal user communications can be kept by the vehicle 102 in a memory. The list of nonverbal user communications can be updated based on a network connection to a centralized database of nonverbal user communications where the database is remote from the vehicle. The list of nonverbal user communications can also be manually programmed by the user 110. The notification 302 can be shown visibly, projected audibly, or transmitted to a user through other suitable techniques.

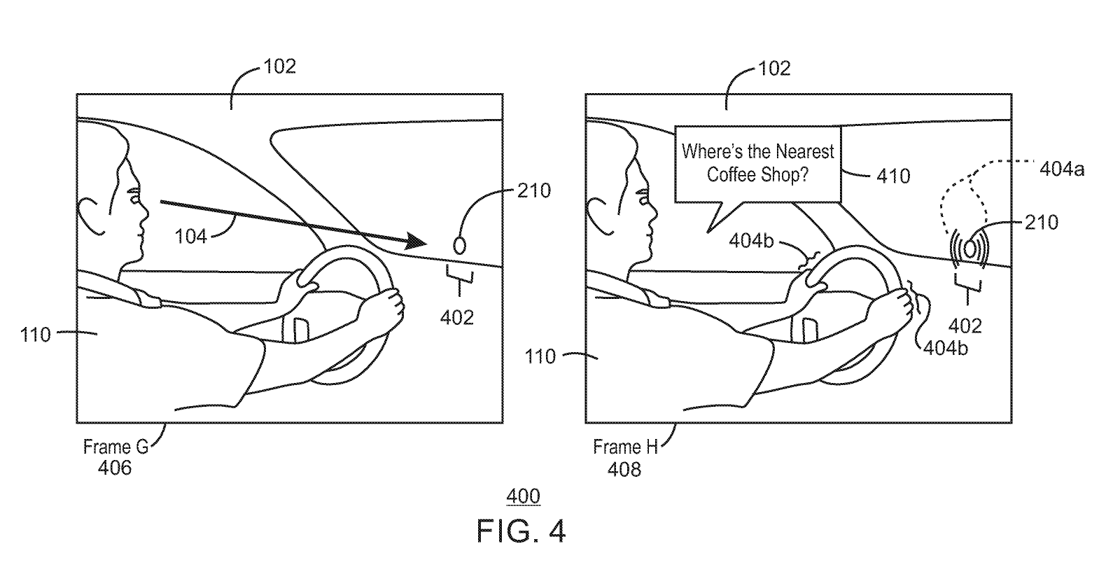

FIG. 4 is a drawing of an example interaction system 400 for a vehicle 102 showing an eye gaze 104 correlating to a virtual assistant location 402 and voice input by the user, resulting in a prompt (404a, 404b) to the user 110. Like numbered items are as described with respect to FIG. 1 and FIG. 2. Frame G (406) shows a first view in time of FIG. 4 and Frame H (408) shows the second view in time through one example use of the presently disclosed technique. Other devices, orders, and timings can also be enabled through these techniques. As shown in Frame G (406), a user's 110 eye gaze 104 correlates to a virtual assistant location 402. In Frame H (408), a virtual assistant 210 can prompt (404a, 404b) the user. The prompting of the user can be through a visual cue 404a as seen in FIG. 4 through the concentric arcs around the virtual assistant 210. The prompting of the user can be through a haptic feedback 404b as felt through the vibrating of the steering wheel. Either prompt (404a, 404b) to the user can indicate a readiness to receive an input from the user, here heard in a spoken input 410 requesting the identity and/or location of a nearby coffee shop.

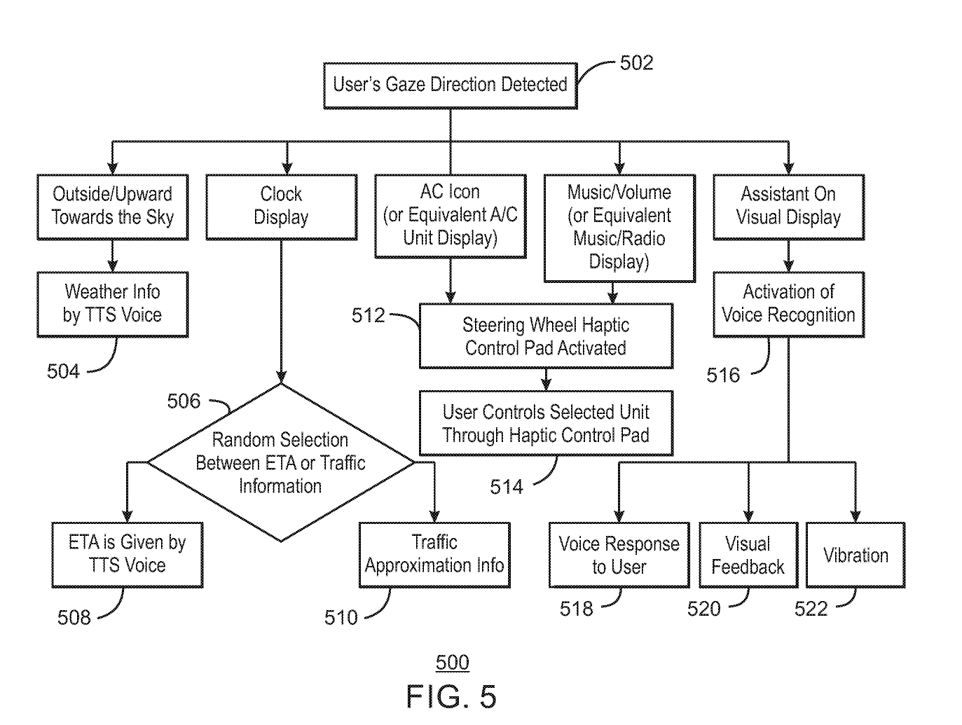

FIG. 5 is a schematic diagram illustrating an example method 500 for an interaction system to operate for a vehicle. Process flow begins at block 502.

At block 502, the user's gaze direction can be detected. The user gaze can be analyzed to indicate what a user is looking at. If a user is looking outward and above the horizon, process flow proceeds to block 504. If a user is looking at a clock display, process flow proceeds to decision block 506. If a user is looking at an air conditioning (AC) icon or a music/volume icon, process flow proceeds to block 512. If a user is looking at an assistant on visual display, process flow proceeds to block 516.

At block 504, a user's gaze direction can be outward and/or upward and above the horizon, weather information can be broadcast by a text-to-speech (TTS) voice. In an example, the TTS voice can be generated by a processor in the vehicle and played over a speaker system of the vehicle.

At block 506, a user's gaze direction can be on a clock display and a random selection between an estimated time of arrival (ETA) or traffic information can be decided. In an example, this random selection can be determined by a randomizer processed by a processor in the vehicle. If ETA is randomly selected, process flow proceeds to block 508. If traffic information is randomly selected, process flow proceeds to block 510. At block 508, an ETA can be given by TTS voice. At block 510, traffic approximation information can be given by TTS voice. The traffic approximation information can convey a congestion rate or volume of traffic near the user's location or along a projected path mapped by a user mapping application.

At block 512, a user's gaze direction can be found either toward an air conditioning (AC) icon or toward a music/volume icon. In this case, the steering wheel haptic control pad can be activated. In an example, the steering wheel haptic control panel can be a control interface to enable a processor to receive touch or other haptic feedback from a user. At block 514, depending on which icon a user gaze direction is aimed at, the user can control that resource through the haptic control pad.

At block 516, a user's gaze direction can be focused on an assistant on a visual display to activate voice recognition. In an example, this can include a virtual assistant 210 discussed above. Voice recognition can be activated to receive and then recognize or interpret the user audio input provided. Voice recognition can identify a user input as an instruction and can respond according to the instruction as appropriate. Process flow can proceed to block 518 when a user input or recognized query leads to a voice response to the user. Process flow can proceed to block 520 when a user input or recognized query leads a visual feedback to the user. Process flow can proceed to block 518 when a user input or recognized query leads to a vibration or other haptic feedback to the user.

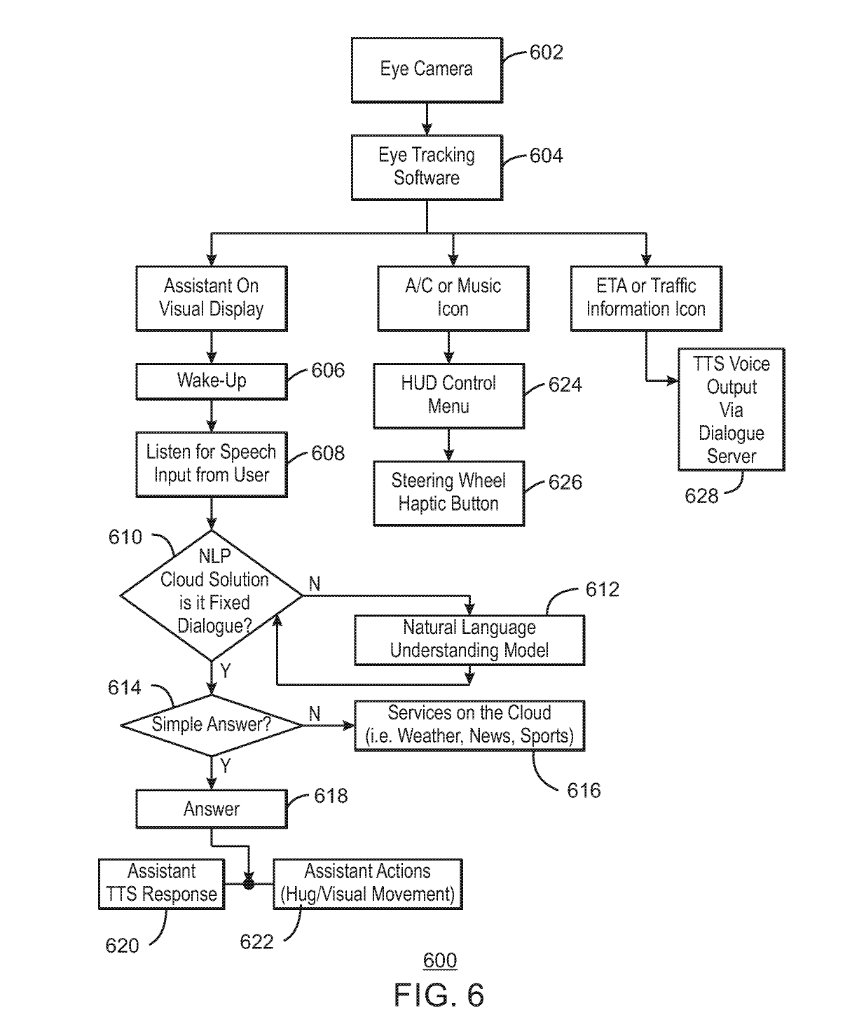

FIG. 6 is a schematic diagram of illustrating an example method 600 for an interaction system to operate for a vehicle. Process flow begins at block 602.

Block 602 represents an eye camera, which can be a digital camera for still images, a video camera, or any other suitable camera positioned so that it can capture images of a user's eyes.

Block 604 represents eye tracking software. In an example, eye tracking software can identify and locate in an image a user's face and eyes. An example of the eye tracking software can track a user's gaze direction based on a detected shape of a user's features, profile, movement of images, detected reflection, and other suitable features. If a user gaze detection is tracked towards an assistant on visual display, process flow proceeds to block 606. If a user gaze detection is tracked towards either an air conditioning or music icon, process flow proceeds to block 624. If a user gaze detection is tracked towards an ETA or traffic information icon, process flow proceeds to block 628.

At block 606, an assistant on a visual display can be instructed to “wake up” a voice recognition and listening resource of a vehicle. An example of a listening resource can include a microphone or other suitable sound detection device. An example of a wake up can include the providing of power to a listening resource or the activation of a powered resource that has not been collecting or transmitting received audio input.

At block 608, the woken up recognition and listening resources can listen for speech input from a user. In an example, the recognition resource can provide an initial speech to text translation for further processing.

At block 610, a decision block shows that text can arrive at a natural language processing (NLP) solution. In an example, a decision can be made as to whether the dialogue is fixed, or understandable as input to a computing system. In an example, text dialogue from a user's audio can include idioms or phrasing that contains more intent and information than each of the recognized words individually. At decision block 610, a decision can be made based on an analysis of the received text as to whether or not the dialogue is understandable as input to a computing device. If no, the dialogue or text is not understandable to a computing device, the process flow proceeds to block 612. If yes, the dialogue is understandable to a computing device, process flow proceeds to decision block 614.

At block 612, a text can be provided to a natural language understanding model. An example of a natural language processing model can be a model that can take text and identify phrases and idioms and determine a meaning based on comparison to previously stored natural language identifications using the same or similar models. After an analysis and identification of phrases in text has been made, process flow proceeds back to block 610, where the results of the natural language model can be assessed.

At block 614, a determination can be made as to whether a user question received can be answered simply by resources local to the vehicle. In an example, a user question that can be answered simply by resources local to the vehicle can include questions of time from an on-board clock, a question as to the amount of gasoline in a tank, question on a current speed, a question on an estimated mileage until a gas tank is empty, and other similar questions. If a text input question or request cannot be answered simply from resources local to the vehicle, the process flow proceeds to block 616. If a text input question or request can be answered simply from resources local to the vehicle, the process flow proceeds to block 618.

At block 616, a text request or query can be sent to an appropriate service or application on a cloud. In an example, an appropriate service can depend on the specific request or query but can include a query as to the weather, headlines and text from various news sources, updates on sports scores, and other similar services. When retrieved, those responses can be provided to the user using visual signaling, audio playback, or by any combination of the two.

At block 618, an answer can be selected from a local resource and then provided to the user based on the type of the response it can be. In an example, a response can include a text response that can be spoken or displayed in text. When a response can be spoken or displayed in text, an assistant can provide a text-to-speech (TTS) response as seen in block 620. When a response cannot be spoken or displayed in text, but instead can include an action, gesture, or movement performed by the assistant, the assistant can perform that action, gesture or movement as seen in block 622. An example of an action, gesture, or movement an assistant can perform includes a visual virtual assistant animating on a display to perform a flip or pace back and forth across a display. Another example of an action, gesture, or movement an assistant can perform includes haptic feedback to a user through either control pads on a steering wheel, haptic feedback through a seat in the vehicle, or a “hug” gesture through a slight tightening and relaxing of a seatbelt fastened around a user.

At block 624, a user gaze direction can be detected as landing on either an air conditioning (A/C) or a music player icon and will indicate which of these icons attracts the user's view through a head up display (HUD) control menu. In an example, a HUD control menu can have an A/C and a music player icon embedded within it, where each icon can be highlighted when a user gaze direction lingers on a particular icon. As discussed above, when a user gaze stays on a particular icon of an A/C or a music player, the resource the user can view, the A/C or music player can also be manually adjusted via a control device.

At block 626, a steering wheel haptic control pad can be activated for the resource the user gaze stays on. In an example, a steering wheel haptic control pad can be a touch sensitive button or strip to allow a user to perform a touch and drag motion to adjust a setting or property of a resource for local resources. In an example of local resources, an A/C, a music player, and other similar accessories can all be resources controlled through a steering wheel haptic control pad.

At block 628, a user has requested an estimated time of arrival or traffic information and can receive a response through a TTS voice output via a dialogue server. In an example, a dialogue server can store incoming user voice input as well as outgoing response data to be converted to speech audio by a TTS resource.

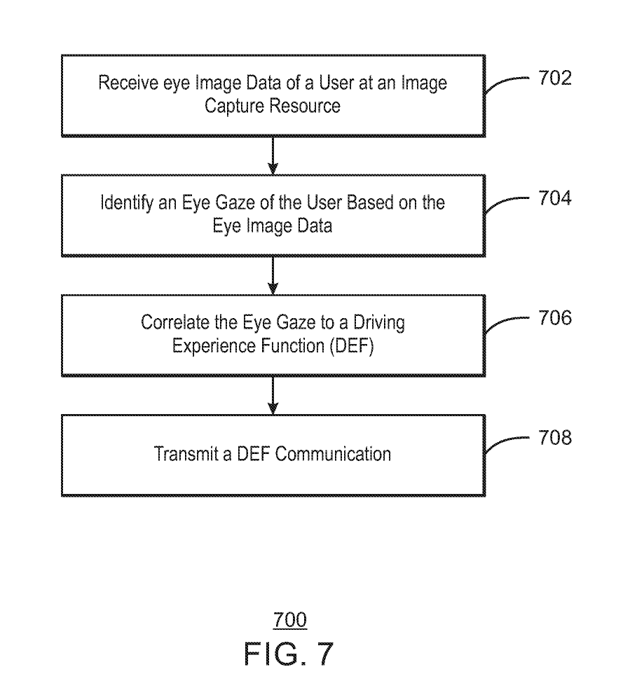

FIG. 7 is a process flow chart of a simplified method 700 for an interaction system to operate for a vehicle. Process flow begins at block 702.

At block 702, the method 700 can include receiving eye image data of a user at an image capture resource. The eye image data can be obtained from a visual image, a video image, or any other suitable representation captured by the image capture resource. The image capture resource can include a camera, a video recorder, or other similar image capture devices. The image capture resource can include image capturing techniques that may not necessarily involve capturing images in the visible light spectrum, but also through the capture of infrared or ultraviolet images. In an example, more than one image capture device can be included as a single image capture resource. In an example, an image capture device can be located in many different locations toward which a user can look.

At block 704, an eye gaze of the user can be identified based on the eye image data. The identification can be made through image recognition software identifying a user eye direction, and may use reflective technology at multiple capture devices to determine when an eye gaze reflection is detected from a user's eye gaze viewing a particular image capture device. Other similar means of identification of an eye gaze based on the eye image data are also included in these examples.

At block 706, the eye gaze can be correlated to a driving experience function (DEF). In an example, the driving experience function can be a stored behavior or eye gaze location that can be linked to a particular query or action to be taken by the processor. In an example, if the eye gaze is in the direction of a virtual assistant location, it can correlate to a DEF of a user command request. A virtual assistant can be a digital support for a user or an input to the interaction system of a vehicle. In an example, the virtual assistant can be displayed visually as through the use of an avatar on a display, can be heard through the broadcast of audio, or may not even display to a user and instead handle queries and provide responses without a detectable presence otherwise. In an example, the broadcast of audio can be a text-to-speech output, or other suitable outputs. As used herein, the virtual assistant location can include instances where a virtual assistant is visualized or symbolized in a particular location in the vehicle that a user can direct their eyes to. In an example, a virtual assistant can be shown as a visual avatar on an area of a front windshield. The virtual assistant location can include the area occupied by the virtual assistant on the front windshield.

In another example, an eye gaze in the direction of a dashboard display location can correlate to a DEF of a read-out request of the dashboard display value. The dashboard display can be a resource on a dashboard or elsewhere in the vehicle where an output is provided but there are no settings to adjust. In an example, the clock in this vehicle can be a dashboard display. As used herein the dashboard display location can be a location of the dashboard display, such as the clock. The read-out request can be a DEF indicated by the user showing that a user may be requesting a broadcast of a value of the dashboard display. In an example, a user can view a fuel tank icon, and the read-out request of the dashboard display value can be a request by the user that the miles remaining in a tank of gas be read out.

In another example, an eye gaze in the direction of a dashboard adjustable instrument location can correlate to a DEF of a control request of a dashboard adjustable instrument. As used herein, the dashboard adjustable instrument can include a number of accessories and functional equipment located or controllable from a visible space of a user in the vehicle. A dashboard adjustable instrument can include a music player, a radio tuner, an air-conditioning temperature, an air conditioner fan speed, a mirror alignment, a light activation, a time setting adjustment, and other similar dashboard components that can be adjusted or manipulated by a user. As used herein, the control request of a dashboard adjustable instrument can refer to a user request to control the dashboard adjustable instrument by modifying the adjustable feature of the dashboard instrument. In an example, a radio can have an adjustable element of volume. In another example, an air conditioning can have an adjustable element of fan speed. In these examples, a control request of a dashboard adjustable instrument could include a request to control the volume or fan speed. Further, the term “dashboard adjustable instrument” may not limit the location of the instruments or their control to the dashboard, however this term was used to indicate a traditional location of many of these instruments.

At block 708, a DEF communication can be transmitted. In an example, any response to a DEF can be considered a DEF communication. In an example, a DEF communication can include a wake up function to a particular system that can be invoked by a particular DEF. A DEF communication can include an activation of a voice receipt resource and a recognition resource. A DEF communication can include a prompt to the user. For example, the prompt can be an indication through haptic feedback, such as vibration of the steering wheel, or through visual cue, a changing of lights or the appearance of an icon, or through audio signaling such as through the sounding of a tone or words. The prompt can indicate a number of things and can vary from one prompt or prompt combination to another. In an example, the prompt can indicate when a user should begin speaking, as the prompt can be triggered by the start of a listening resource. Similarly, the prompt can indicate to a user when a listening resource has ended listening. In an example, a DEF communication can include an activation of a physical control to receive input from a user. For example, the steering wheel can include a single physically touchable control that can be used to control adjustable features in a vehicle when a user's eye gaze correlates to a dashboard adjustable instrument.

In another example, the DEF communication comprises an instruction to broadcast to the user a value of the dashboard display. The instruction to broadcast can include an instruction to broadcast through visible means such as a display and can also include audio means such as a text-to-speech program implemented by the vehicle.

In another example, DEF communication can include an activation of a displayable control to be visible to the user. The displayable control can include a list of options for an adjustable instrument that can be presented in a popup menu presented on a display of the vehicle, a projected image in a line of sight of a user on a front windshield, or a projection of an image into the eyes of the user based on the captured eye image data. When the displayable control appears visibly to the user, the image capture resource can receive a second eye image data. A second eye gaze of the user can be identified based on the second eye image data with this second eye gaze correlating to a selection of an option shown in the displayable control. Based on the detected eye gaze on the displayable control, a DEF communication can be sent to adjust the adjustable instrument.

In an example, any received audio input from a user can be transmitted to a natural language understanding model to generate a user input interpretation. The natural language understanding model can be local to the vehicle and can also be remote from the vehicle and sent through a network or direct connection to other computing devices, a server, or cloud of servers. The natural language understanding model can be used to understand more intuitive phrasing that a user can use and can translate the user's words and phrases into a more computer understandable text. Depending on what the natural language understanding model returns, the processor can provide a prompt to the user to be based on the user input interpretation. The prompt can include an instruction or a request of another component or device and depends on whether any instructions were provided by the natural language understanding model.

In an example, the eye gaze can correlate to a DEF of a nonverbal user communication. The nonverbal user communication can be a detection that a user's eyes are closed for a threshold period of time, which can indicate a drowsy user. The instruction to notify the user can include at least one of the following: an audio signal, haptic feedback, and a visual cue to alert the user to their potentially drowsy state. In an example, the nonverbal communication can be a user glancing through the front windshield or car window, upward above the horizon, in a way that indicates a curiosity or specific inquiry about the weather, including the current weather or the weather to later be forecast along a route or in a particular region. An instruction provided by the DEF communication can notify the user through at least one of the following: an audio signal and a visual cue of the weather in their present location or along a particular route.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An interaction system for a vehicle, comprising:
an image capture resource to receive eye image data of a user;
a processor to identify an eye gaze of the user based on the eye image data, the processor to correlate the eye gaze to a driving experience function (DEF), and the processor to transmit a DEF communication in response to the correlation.

2. The system of claim 1, wherein:
if the eye gaze is in a direction of a virtual assistant location, the eye gaze correlates to a DEF of a user command request; and
the DEF communication comprises an activation of voice receipt and recognition resources as well as a prompt to the user.

3. The system of claim 2, wherein the prompt to the user comprises at least one of an audio signal, haptic feedback, and a visual cue.

4. The system of claim 2, wherein the processor is to transmit a received audio input of a user to a natural language understanding model to generate a user input interpretation, the prompt to the user being based on the user input interpretation.

5. The system of claim 1, wherein:
if the eye gaze is in the direction of a dashboard adjustable instrument location, the eye gaze correlates to a DEF of a control request of a dashboard adjustable instrument; and
the DEF communication comprises an activation of a physical control to receive input from a user.

6. The system of claim 1, wherein:
if the eye gaze is in the direction of a dashboard adjustable instrument location, the eye gaze correlates to a DEF of a control request of a dashboard adjustable instrument; and
the DEF communication comprises an activation of a displayable control to be visible to the user;
the image capture resource to receive a second eye image data;
the processor to identify a second eye gaze of the user based on the second eye image data and to correlate the second eye gaze to a selection of an option to be shown on the displayable control, the option correlating to an adjustment of the dashboard adjustable instrument.

7. The system of claim 1, wherein:
if the eye gaze is in the direction of a dashboard display location, the eye gaze correlates to a DEF of a read-out request of a dashboard display function; and
the DEF communication comprises an instruction to broadcast to the user a value of the dashboard display.

8. The system of claim 1, wherein:
the eye gaze correlates to a DEF of a nonverbal user communication; and
the DEF communication comprises an instruction to notify the user based on the nonverbal user communication.

9. The system of claim 8, wherein the nonverbal user communication is to indicate a drowsy user and the instruction to notify the user comprises at least one of an audio signal, haptic feedback, and a visual cue.

10. The system of claim 8, wherein the nonverbal communication is to indicate a weather inquiry and the instruction to notify the user comprises a least one of an audio signal and a visual cue.

11. A method for user and vehicle interaction, comprising:
receiving eye image data of a user at an image capture resource;
identifying, with a processor, an eye gaze of the user based on the eye image data;
correlating, with the processor, the eye gaze to a driving experience function (DEF); and
transmitting, with a processor, and in response to the correlating, a DEF communication.

12. The method of claim 11, wherein:
if the eye gaze is in the direction of a virtual assistant location, the eye gaze correlates to a DEF of a user command request; and
the DEF communication comprises an activation of voice receipt and recognition resources as well as a prompt to the user.

13. The method of claim 12, wherein the prompt to the user comprises at least one of an audio signal, haptic feedback, and a visual cue.

14. The method of claim 12, wherein the processor transmits a received audio input of a user to a natural language understanding model to generate a user input interpretation, the prompt to the user being based on the user input interpretation.

15. The method of claim 11, wherein:
if the eye gaze is in the direction of a dashboard adjustable instrument location, the eye gaze correlates to a DEF of a control request of a dashboard adjustable instrument; and
the DEF communication comprises an activation of a physical control to receive input from a user.

16. The method of claim 11, wherein:
if the eye gaze is in the direction of a dashboard adjustable instrument location, the eye gaze correlates to a DEF of a control request of a dashboard adjustable instrument; and
the DEF communication comprises an activation of a displayable control to be visible to the user;
the image capture resource to receive a second eye image data;
the processor to identify a second eye gaze of the user based on the second eye image data and to correlate the second eye gaze to a selection of an option to be shown on the displayable control, the option correlating to an adjustment of the dashboard adjustable instrument.

17. The method of claim 11, wherein:
if the eye gaze is in the direction of a dashboard display location, the eye gaze correlates to a DEF of a read-out request of a dashboard display function; and
the DEF communication comprises an instruction to broadcast to the user a value of the dashboard display.

18. The method of claim 11, wherein:
the eye gaze correlates to a DEF of a nonverbal user communication; and
the DEF communication comprises an instruction to notify the user based on the nonverbal user communication.

19. The method of claim 18, wherein the nonverbal user communication is to indicate a drowsy user and the instruction to notify the user comprises at least one of an audio signal, haptic feedback, and a visual cue.

20. The method of claim 11, wherein the nonverbal communication is to indicate a weather inquiry and the instruction to notify the user comprises a least one of an audio signal and a visual cue.

21. A vehicle for interaction with a user comprising:
an ignition system;
an image capture resource to receive eye image data of a user;
a processor to identify an eye gaze of the user based on the eye image data and to correlate the eye gaze to a driving experience function (DEF), the processor to transmit a DEF communication in response to the correlation.

22. The vehicle of claim 21, wherein:
if the eye gaze is in the direction of a virtual assistant location, the eye gaze correlates to a DEF of a user command request; and
the DEF communication comprises an activation of voice receipt and recognition resources as well as a prompt to the user.

23. The vehicle of claim 22, wherein the prompt to the user comprises at least one of an audio signal, haptic feedback, and a visual cue.

24. The vehicle of claim 22, wherein the processor is to transmit a received audio input of a user to a natural language understanding model to generate a user input interpretation, the prompt to the user being based on the user input interpretation.

25. The vehicle of claim 21, wherein:
if the eye gaze is in the direction of a dashboard adjustable instrument location, the eye gaze correlates to a DEF of a control request of a dashboard adjustable instrument; and
the DEF communication comprises an activation of a physical control to receive input from a user.

26. The vehicle of claim 21, wherein:
if the eye gaze is in the direction of a dashboard adjustable instrument location, the eye gaze correlates to a DEF of a control request of a dashboard adjustable instrument; and
the DEF communication comprises an activation of a displayable control to be visible to the user;
the image capture resource to receive a second eye image data;
the processor to identify a second eye gaze of the user based on the second eye image data and to correlate the second eye gaze to a selection of an option to be shown on the displayable control, the option correlating to an adjustment of the dashboard adjustable instrument.

27. The vehicle of claim 21, wherein:
if the eye gaze is in the direction of a dashboard display location, the eye gaze correlates to a DEF of a read-out request of a dashboard display function; and
the DEF communication comprises an instruction to broadcast to the user a value of the dashboard display.

28. The vehicle of claim 21, wherein:
the eye gaze correlates to a DEF of a nonverbal user communication; and
the DEF communication comprises an instruction to notify the user based on the nonverbal user communication.

29. The vehicle of claim 28, wherein the nonverbal user communication is to indicate a drowsy user and the instruction to notify the user comprises at least one of an audio signal, haptic feedback, and a visual cue.

30. The vehicle of claim 28, wherein the nonverbal communication is to indicate a weather inquiry and the instruction to notify the user comprises a least one of an audio signal and a visual cue.
